(19) United States
(12) Patent Application Publication
(10) Pub. No.: US 2010/0107048 A1
(43) Pub. Date: Apr. 29, 2010

(54) DOCUMENT PROCESSOR AND DOCUMENT PROCESSING METHOD

(75) Inventor: Takashi Takahara, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: JUSTSYSTEMS CORPORATION, TOKUSHIMA-SHI, TOKUSHIMA (JP)

(21) Appl. No.: 12/532,370

(22) PCT Filed: Mar. 12, 2008
(86) PCT No.: PCT/JP2008/000555

§ 371 Date: Sep. 21, 2009

(30) Foreign Application Priority Data
Mar. 21, 2007 (JP) 2007-073756

(51) Int. Cl. G06F 17/00

(52) U.S. Cl. 715/219; 715/220; 715/212

(57) ABSTRACT

A document processing apparatus includes a spreadsheet unit which processes, in a spreadsheet sheet format, a document described in a markup language. The spreadsheet unit includes: a display unit which displays, in a spreadsheet format, data which is contained in a document and which is described in a tag set defined for a spreadsheet; and an editing unit which inserts, into the spreadsheet, data which is contained in the document and which is described in a tag set that differs from the tag set for the spreadsheet.

### TECHNICAL FIELD

The present invention relates to a document processing technique, and particularly to a document processing apparatus and a document processing method for processing a document described in a markup language.

### BACKGROUND ART

XML has been attracting attention as a format that allows the user to share data with other users via a network. This encourages the development of applications for creating, displaying, and editing XML documents (see Patent document 1, for example). The XML documents are created based upon a vocabulary (tag set) defined according to a document type definition or the like.
[Patent Document 1]

Japanese Patent Application Laid-open No. 2001-290804

### DISCLOSURE OF THE INVENTION

### Problem to Be Solved by the Invention

The XML technique allows the user to define vocabularies as desired. In theory, this allows a limitless number of vocabularies to be created. The present applicant has developed a technique for appropriately processing XML documents which can be flexibly designed in this manner. Furthermore, the present applicant has arrived at a highly user-friendly data processing technique that takes full advantage of the benefits of XML.

The present invention has been made in view of such a situation. Accordingly, it is a general purpose of the present invention to provide a technique for appropriately processing data structured by a markup language.

### Means to Solve the Problem

An embodiment of the present invention relates to a document processing apparatus. The document processing apparatus comprises: a display unit which displays, in a spreadsheet format, data which is contained in a document and which is described in a tag set defined for a spreadsheet; and an editing unit which inserts, into the spreadsheet, data described in the document in a tag set that differs from the tag set for the spreadsheet.

Also, the editing unit may store pointer information pointing to data, which has been designated as insertion target data and which is described in a tag set that differs from the tag set for the spreadsheet, in an element of the tag set for the spreadsheet which corresponds to a cell designated as a data insertion destination.

Also, an arrangement may be made in which, upon receiving a notice which indicates that the insertion target data has been edited, the editing unit edits, with reference to the insertion target data thus edited, an element that corresponds to the cell into which the insertion target data was inserted.

Also, the editing unit may define a dedicated function using data described in the tag set, in increments of tag sets used to describe the insertion target data. Also, an arrangement may be made in which, upon receiving an input of an expression containing the function thus defined, the editing unit inserts the result obtained by calculating the expression.

Also, an arrangement may be made in which, upon receiving an instruction to insert a fragment composed of multiple elements contained in the document, the editing unit inserts the fragment as the insertion target data.

Also, an arrangement may be made in which, when the editing unit receives an instruction for the insertion target data, the editing unit presents a screen in which the data contained in the document is displayed in a tree format, which allows the user to input an instruction for the insertion target data.

Another embodiment of the present invention relates to a document processing method. The document processing method comprises: displaying, in a spreadsheet format, data which is contained in a document and which is described in a tag set defined for a spreadsheet; and inserting, into the spreadsheet, data which is contained in the document and which is described in a tag set that differs from the tag set for the spreadsheet.

It should be noted that any combination of the aforementioned components may be made, and any manifestation of the present invention may be mutually substituted between a method, apparatus, system, and so forth, which are effective as an embodiment of the present invention.

### Advantage of the Present Invention

The present invention provides a technique for appropriately processing data structured by a markup language.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram which shows a configuration of a document processing apparatus according to the base technology;

FIG. 2 is a diagram which shows an example of an XML document which is a processing target;

FIG. 3 is a diagram which shows an example in which the XML document shown in FIG. 2 is mapped to a table described in HTML;

FIG. 4A is a diagram which shows an example of a definition file used for mapping the XML document shown in FIG. 2 to the table shown in FIG. 3;

FIG. 4B is a diagram which shows an example of a definition file used for mapping the XML document shown in FIG. 2 to the table shown in FIG. 3;

FIG. 5 is a diagram which shows an example of a screen on which the XML document, which has been described in a marks managing vocabulary and which is shown in FIG. 2, is displayed after having been mapped to HTML according to the correspondence shown in FIG. 3;

FIG. 6 is a diagram which shows an example of a graphical user interface provided by a definition file creating unit, which allows the user to create a definition file;

FIG. 7 is a diagram which shows another example of a screen layout created by the definition file creating unit;

FIG. 8 is a diagram which shows an example of an editing screen for an XML document, as provided by the document processing apparatus;

FIG. 9 is a diagram which shows another example of an XML document which is to be edited by the document processing apparatus;

FIG. 10 is a diagram which shows an example of a screen on which the document shown in FIG. 9 is displayed;

FIG. 11 is a diagram which shows a configuration of a document processing apparatus according to an embodiment;

FIG. 12A is a diagram which shows a sample document;

FIG. 12B is a diagram which shows the sample document;

FIG. 13 is a diagram which shows an example of a screen in which the sample document shown in FIGS. 12A and 12B is displayed;

FIG. 14 is a diagram which shows an example of a data selection reception screen presented by an editing unit;

FIG. 15 is a diagram which shows an example of a screen after the data of a reference source has been updated;

FIG. 16 is a diagram which shows an example of a screen after a fragment has been inserted into a cell; and

FIG. 17 is a diagram which shows an example of a screen after a dedicated function has been inserted into a spreadsheet.

### DESCRIPTION OF THE REFERENCE NUMERALS

20 document processing apparatus, 22 main control unit, 24 editing unit, 30 DOM unit, 32 DOM provider, 34 DOM builder, 36 DOM writer, 40 CSS unit, 42 CSS parser, 44 CSS provider, 46 rendering unit, 50 HTML unit, 52, 62 control unit, 54, 64 editing unit, 56, 66 display unit, 60 SVG unit, 70 spreadsheet unit, 72 control unit, 74 editing unit, 76 display unit, 78 acquisition unit, 80 VC unit, 82 mapping unit, 84 definition file acquisition unit, 86 definition file creating unit, 100 document processing apparatus

### BEST MODE FOR CARRYING OUT THE INVENTION

### (Base Technology)

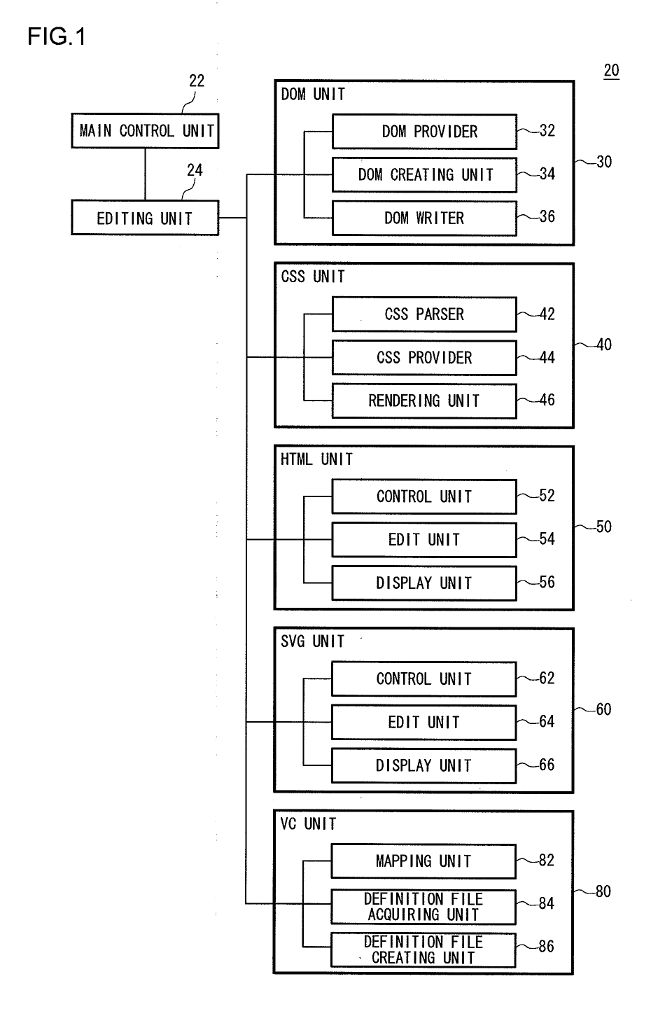

FIG. 1 illustrates a structure of a document processing apparatus 20 according to Base Technology. The document processing apparatus 20 processes a structured document where data in the document are classified into a plurality of components having a hierarchical structure. Represented in Base Technology is an example in which an XML document, as one type of a structured document, is processed. The document processing apparatus 20 is comprised of a main control unit 22, an editing unit 24, a DOM unit 30, a CSS unit 40, an HTML unit 50, an SVG unit 60 and a VC unit 80 which serves as an example of a conversion unit. In terms of hardware components, these unit structures may be realized by any conventional processing system or equipment, including a CPU or memory of any computer, a memory-loaded program, or the like. Here, the drawing shows a functional block configuration which is realized by cooperation between the hardware components and software components. Thus, it should be understood by a person skilled in the art that these functional blocks can be realized in a variety of forms by hardware only, software only or the combination thereof.

The main control unit 22 provides for the loading of a plug-in or a framework for executing a command. The editing unit 24 provides a framework for editing XML documents. Display and editing functions for a document in the document processing apparatus 20 are realized by plug-ins, and the necessary plug-ins are loaded by the main control unit 22 or the editing unit 24 according to the type of document under consideration. The main control unit 22 or the editing unit 24 determines which vocabulary or vocabularies describes the content of an XML document to be processed, by referring to a name space of the document to be processed, and loads a plug-in for display or editing corresponding to the thus determined vocabulary so as to execute the display or the editing. For instance, an HTML unit 50, which displays and edits HTML documents, and an SVG unit 60, which displays and edits SVG documents, are implemented in the document processing apparatus 20. That is, a display system and an editing system are implemented as plug-ins for each vocabulary (tag set), so that when an HTML document and an SVG document are edited, HTML unit 50 and the SVG unit 60 are loaded, respectively. As will be described later, when compound documents, which contain both HTML and SVG components, are to be processed, both HTML unit 50 and the SVG unit 60 are loaded.

By implementing the above structure, a user can select so as to install only necessary functions, and can add or delete a function or functions at a later stage, as appropriately. Thus, the storage area of a recording medium, such as a hard disk, can be effectively utilized, and the wasteful use of memory can be prevented at the time of executing programs. Furthermore, since the capability of this structure is highly expandable, a developer can deal with new vocabularies in the form of plug-ins, and thus the development process can be readily facilitated. As a result, the user can also add a function or functions easily at low cost by adding a plug-in or plug-ins.

The editing unit 24 receives an event, which is an editing instruction, from the user via the user interface. Upon reception of such an event, the editing unit 24 notifies a suitable plug-in or the like of this event, and controls the processing such as redoing this event, canceling (undoing) this event, etc.

The DOM unit 30 includes a DOM provider 32, a DOM builder 34 and a DOM writer 36. The DOM unit 30 realizes functions in compliance with a document object model (DOM), which is defined to provide an access method used for handling data in the form of an XML document. The DOM provider 32 is an implementation of a DOM that satisfies an interface defined by the editing unit 24. The DOM builder 34 creates DOM trees from XML documents. As will be described later, when an XML document to be processed is mapped to another vocabulary by the VC unit 80, a source tree, which corresponds to the XML document in a mapping source, and a destination tree, which corresponds to the XML document in a mapping destination, are created. At the end of editing, for example, the DOM writer 36 outputs a DOM tree as an XML document.

The CSS unit 40, which provides a display function conforming to CSS, includes a CSS parser 42, a CSS provider 44 and a rendering unit 46. The CSS parser 42 has a parsing function for analyzing the CSS syntax. The CSS provider 44 is an implementation of a CSS object and performs CSS cascade processing on the DOM tree. The rendering unit 46 is a CSS rendering engine and is used to display documents, described in a vocabulary such as HTML, which are laid out using CSS.

HTML unit 50 displays or edits documents described in HTML. The SVG unit 60 displays or edits documents described in SVG. These display/editing systems are realized in the form of plug-ins, and each system is comprised of a display unit (also designated herein as a “canvas”) 56 and 66, which displays documents, a control unit (also designated herein as an “editlet”) 52 and 62, which transmits and receives events containing editing commands, and an edit unit (also designated herein as a “zone”) 54 and 64, which edits the DOM according to the editing commands. Upon the control unit 52 or 62 receiving a DOM tree editing command from an external source, the edit unit 54 or 64 modifies the DOM tree and the display unit 56 or 66 updates the display. These units have a structure similar to the framework of the so-called MVC (Model-View-Controller). With such a structure, in general, the display units 56 and 66 correspond to “View”. On the other hand, the control units 52 and 62 correspond to “Controller”, and the edit units 54 and 64 and DOM instance corresponds to “Model”. The document processing apparatus 20 according to the Base Technology allows an XML document to be edited according to each given vocabulary, as well as providing a function of editing HTML document in the form of tree display. HTML unit 50 provides a user interface for editing an HTML document in a manner similar to a word processor, for example. On the other hand, the SVG unit 60 provides a user interface for editing an SVG document in a manner similar to an image drawing tool.

The VC unit 80 includes a mapping unit 82, a definition file acquiring unit 84 and a definition file generator 86. The VC unit 80 performs mapping of a document, which has been described in a particular vocabulary, to another given vocabulary, thereby providing a framework that allows a document to be displayed and edited by a display/editing plug-in corresponding to the vocabulary to which the document is mapped. In the Base Technology, this function is called a vocabulary connection (VC). In the VC unit 80, the definition file acquiring unit 84 acquires a script file in which the mapping definition is described. Here, the definition file specifies the correspondence (connection) between the Nodes for each Node. Furthermore, the definition file may specify whether or not editing of the element values or attribute values is permitted. Furthermore, the definition file may include operation expressions using the element values or attribute values for the Node. Detailed description will be made later regarding these functions. The mapping unit 82 instructs the DOM builder 34 to create a destination tree with reference to the script file acquired by the definition file acquiring unit 84. This manages the correspondence between the source tree and the destination tree. The definition file generator 86 offers a graphical user interface which allows the user to create a definition file.

The VC unit 80 monitors the connection between the source tree and the destination tree. Upon reception of an editing instruction from the user via a user interface provided by a plug-in that handles a display function, the VC unit 80 first modifies a relevant Node of the source tree. As a result, the DOM unit 30 issues a mutation event indicating that the source tree has been modified. Upon reception of the mutation event thus issued, the VC unit 80 modifies a Node of the destination tree corresponding to the modified Node, thereby updating the destination tree in a manner that synchronizes with the modification of the source tree. Upon reception of a mutation event that indicates that the destination tree has been modified, a plug-in having functions of displaying/editing the destination tree, e.g., HTML unit 50, updates a display with reference to the destination tree thus modified. Such a structure allows a document described in any vocabulary, even a minor vocabulary used in a minor user segment, to be converted into a document described in another major vocabulary. This enables such a document described in a minor vocabulary to be displayed, and provides an editing environment for such a document.

An operation in which the document processing apparatus 20 displays and/or edits documents will be described herein below. When the document processing apparatus 20 loads a document to be processed, the DOM builder 34 creates a DOM tree from the XML document. The main control unit 22 or the editing unit 24 determines which vocabulary describes the XML document by referring to a name space of the XML document to be processed. If the plug-in corresponding to the vocabulary is installed in the document processing apparatus 20, the plug-in is loaded so as to display/edit the document. If, on the other hand, the plug-in is not installed in the document processing apparatus 20, a check shall be made to see whether a mapping definition file exists or not. And if the definition file exits, the definition file acquiring unit 84 acquires the definition file and creates a destination tree according to the definition, so that the document is displayed/edited by the plug-in corresponding to the vocabulary which is to be used for mapping. If the document is a compound document containing a plurality of vocabularies, relevant portions of the document are displayed/edited by plug-ins corresponding to the respective vocabularies, as will be described later. If the definition file does not exist, a source or tree structure of a document is displayed and the editing is carried out on the display screen.

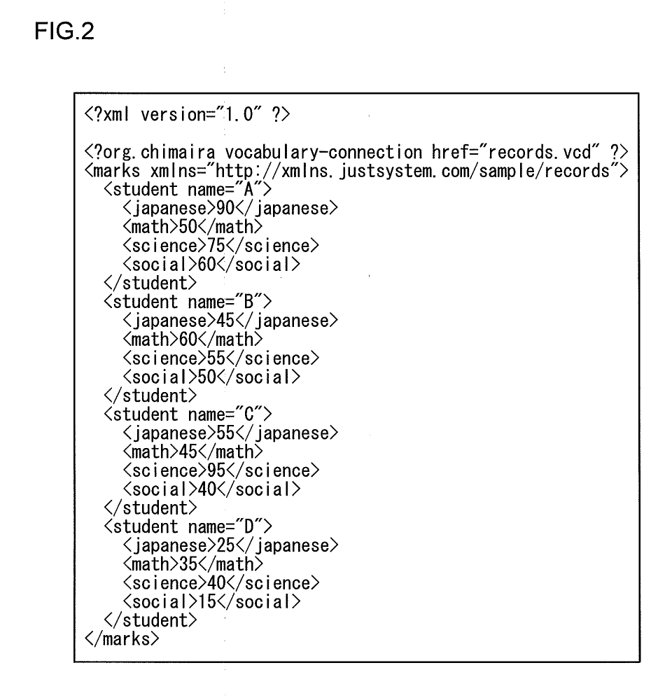

FIG. 2 shows an example of an XML document to be processed. According to this exemplary illustration, the XML document is used to manage data concerning grades or marks that students have earned. A component “marks”, which is the top Node of the XML document, includes a plurality of components “student” provided for each student under “marks”. The component “student” has an attribute “name” and contains, as child elements, the subjects “japanese”, “mathematics”, “science”, and “social_studies”. The attribute “name” stores the name of a student. The components “japanese”, “mathematics”, “science” and “social_studies” store the test scores for the subjects Japanese, mathematics, science, and social studies, respectively. For example, the marks of a student whose name is “A” are “90” for Japanese, “50” for mathematics, “75” for science and “60” for social studies. Hereinafter, the vocabulary (tag set) used in this document will be called “marks managing vocabulary”.

Here, the document processing apparatus 20 according to the Base Technology does not have a plug-in which conforms to or handles the display/editing of marks managing vocabularies. Accordingly, before displaying such a document in a manner other than the source display manner or the tree display manner, the above-described VC function is used. That is, there is a need to prepare a definition file for mapping the document, which has been described in the marks managing vocabulary, to another vocabulary, which is supported by a corresponding plug-in, e.g., HTML or SVG. Note that description will be made later regarding a user interface that allows the user to create the user's own definition file. Now, description will be made below regarding a case in which a definition file has already been prepared.

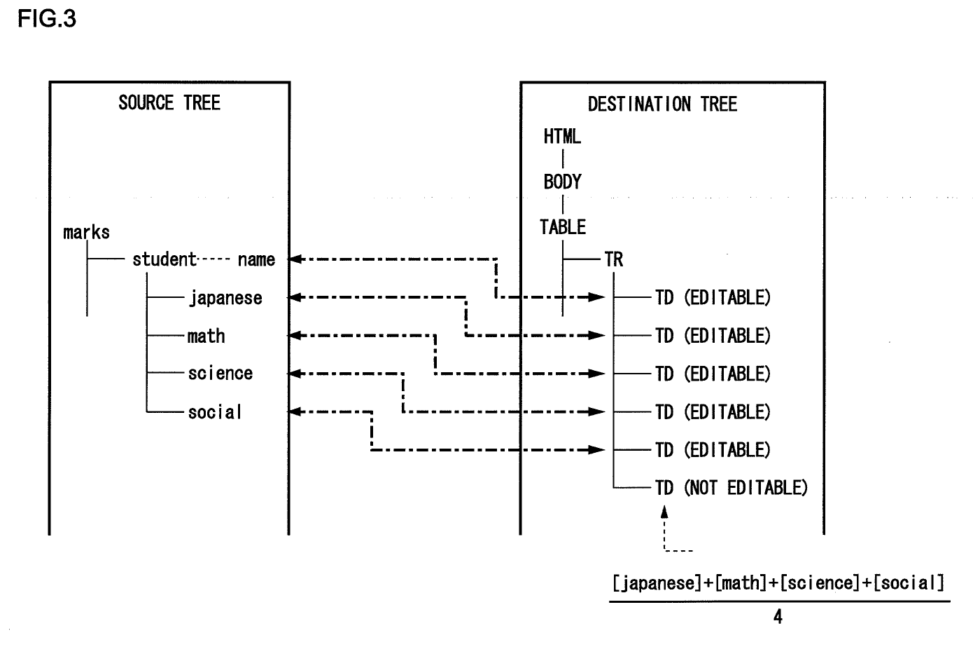

FIG. 3 shows an example in which the XML document shown in FIG. 2 is mapped to a table described in HTML. In an example shown in FIG. 3, a “student” Node in the marks managing vocabulary is associated with a row (“TR” Node) of a table (“TABLE” Node) in HTML. The first column in each row corresponds to an attribute value “name”, the second column to a “Japanese” Node element value, the third column to a “mathematics” Node element value, the fourth column to a “science” Node element value and the fifth column to a “social_studies” Node element value. As a result, the XML document shown in FIG. 2 can be displayed in an HTML tabular format. Furthermore, these attribute values and element values are designated as being editable, so that the user can edit these values on a display screen using an editing function of HTML unit 50. In the sixth column, an operation expression is designated for calculating a weighted average of the marks for Japanese, mathematics, science and social studies, and average values of the marks for each student are displayed. In this manner, more flexible display can be effected by making it possible to specify the operation expression in the definition file, thus improving the users' convenience at the time of editing. In this example shown in FIG. 3, editing is designated as not being possible in the sixth column, so that the average value alone cannot be edited individually. Thus, in the mapping definition it is possible to specify editing or no editing so as to protect the users against the possibility of performing erroneous operations.

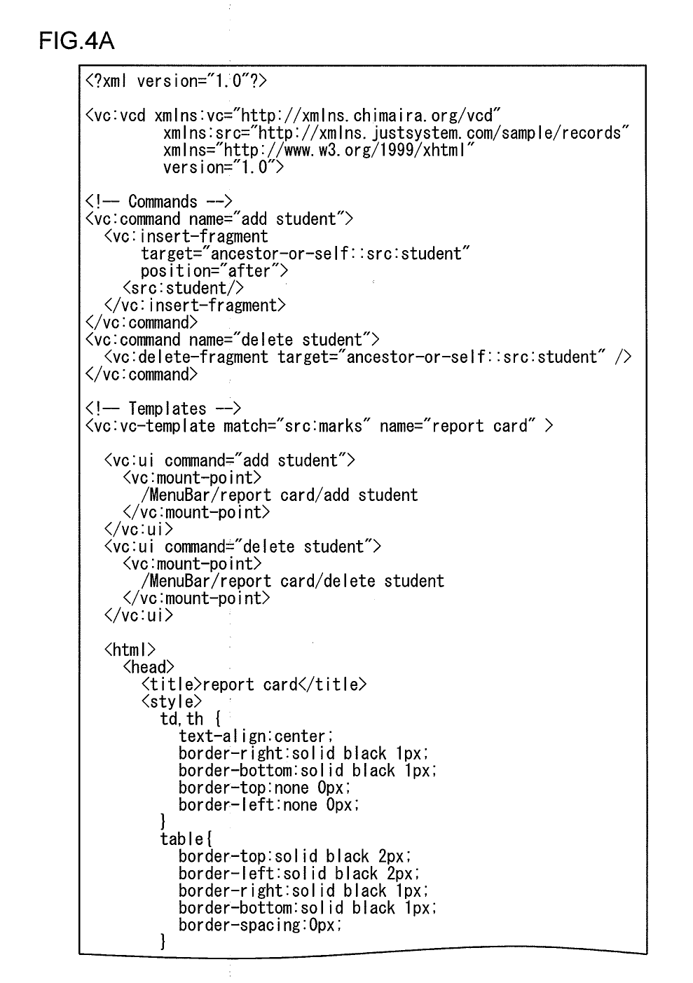

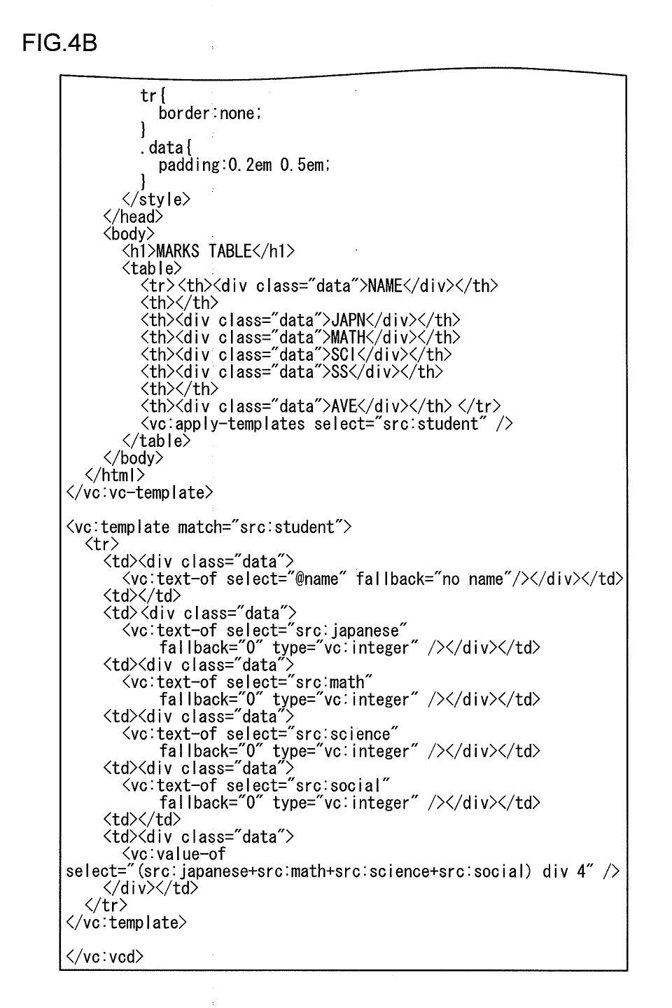

FIG. 4A and FIG. 4B illustrate an example of a definition file to map the XML document shown in FIG. 2 to the table shown in FIG. 3. This definition file is described in script language defined for use with definition files. In the definition file, definitions of commands and templates for display are described. In the example shown in FIG. 4A and FIG. 4B, “add student” and “delete student” are defined as commands, and an operation of inserting a Node “student” into a source tree and an operation of deleting the Node “student” from the source tree, respectively, are associated with these commands. Furthermore, the definition file is described in the form of a template, which describes that a header, such as “name” and “Japanese”, is displayed in the first row of a table and the contents of the Node “student” are displayed in the second and subsequent rows. In the template displaying the contents of the Node “student”, a term containing “text-of” indicates that editing is permitted, whereas a term containing “value-of” indicates that editing is not permitted. Among the rows where the contents of the Node “student” are displayed, an operation expression “(src:japanese+src:mathematics+scr:science+scr:social_studies) div 4” is described in the sixth row. This means that the average of the student's marks is displayed.

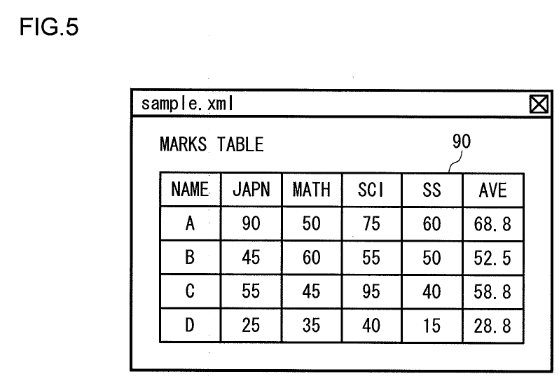

FIG. 5 shows an example of a display screen on which an XML document described in the marks managing vocabulary shown in FIG. 2 is displayed by mapping the XML document to HTML using the correspondence shown in FIG. 3. Displayed from left to right in each row of a table 90 are the names of each student, marks for Japanese, marks for mathematics, marks for science, marks for social studies and the averages thereof. The user can edit the XML document on this screen. For example, when the value in the second row and the third column is changed to “70”, the element value in the source tree corresponding to this Node, that is, the marks of student “B” for mathematics are changed to “70”. At this time, in order to have the destination tree follow the source tree, the VC unit 80 changes a relevant portion of the destination tree accordingly, so that HTML unit 50 updates the display based on the destination tree thus changed. Hence, the marks of student “B” for mathematics are changed to “70”, and the average is changed to “55” in the table on the screen.

On the screen as shown in FIG. 5, commands like “add student” and “delete student” are displayed in a menu as defined in the definition file shown in FIG. 4A and FIG. 4B. When the user selects a command from among these commands, a Node “student” is added or deleted in the source tree. In this manner, with the document processing apparatus 20 according to the Base Technology, it is possible not only to edit the element values of components in a lower end of a hierarchical structure but also to edit the hierarchical structure. An edit function for editing such a tree structure may be presented to the user in the form of commands. Furthermore, a command to add or delete rows of a table may, for example, be linked to an operation of adding or deleting the Node “student”. A command to embed other vocabularies therein may be presented to the user. This table may be used as an input template, so that marks data for new students can be added in a fill-in-the-blank format. As described above, the VC function allows a document described in the marks managing vocabulary to be edited using the display/editing function of HTML unit 50.

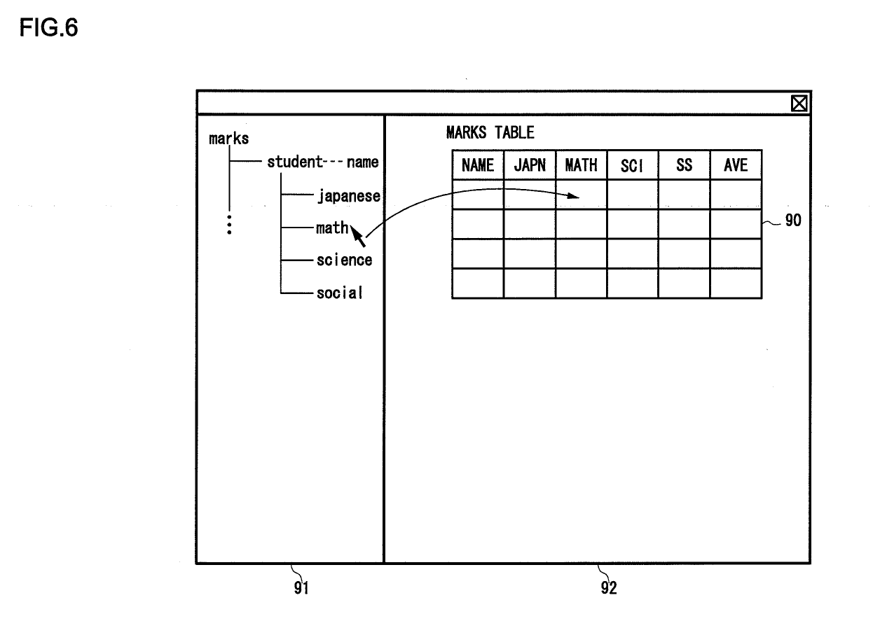

FIG. 6 shows an example of a graphical user interface, which the definition file generator 86 presents to the user, in command for the user to create a definition file. An XML document to be mapped is displayed in a tree in a left-hand area 91 of a screen. The screen layout of an XML document after mapping is displayed in a right-hand area 92 of the screen. This screen layout can be edited by HTML unit 50, and the user creates a screen layout for displaying documents in the right-hand area 92 of the screen. For example, a Node of the XML document which is to be mapped, which is displayed in the left-hand area 91 of the screen, is dragged and dropped into HTML screen layout in the right-hand area 92 of the screen using a pointing device such as a mouse, so that a connection between a Node at a mapping source and a Node at a mapping destination is specified. For example, when “mathematics,” which is a child element of the element “student,” is dropped to the intersection of the first row and the third column in a table 90 on HTML screen, a connection is established between the “mathematics” Node and a “TD” Node in the third column. Either editing or no editing can be specified for each Node. Moreover, the operation expression can be embedded in a display screen. When the screen editing is completed, the definition file generator 86 creates definition files, which describe connections between the screen layout and Nodes.

Viewers or editors which can handle major vocabularies such as XHTML, MathML and SVG have already been developed. However, it does not serve any practical purpose to develop dedicated viewers or editors for such documents described in the original vocabularies as shown in FIG. 2. If, however, the definition files for mapping to other vocabularies are created as mentioned above, the documents described in the original vocabularies can be displayed and/or edited utilizing the VC function without the need to develop a new viewer or editor.

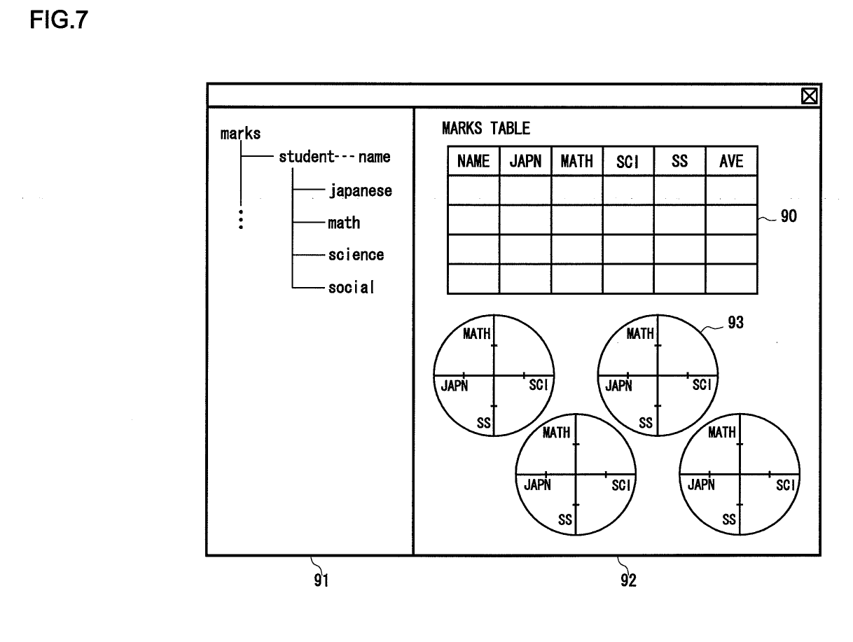

FIG. 7 shows another example of a screen layout created by the definition file generator 86. In the example shown in FIG. 7, a table 90 and circular graphs 93 are created on a screen for displaying XML documents described in the marks managing vocabulary. The circular graphs 93 are described in SVG. As will be discussed later, the document processing apparatus 20 according to the Base Technology can process a compound document described in the form of a single XML document according to a plurality of vocabularies. That is why the table 90 described in HTML and the circular graphs 93 described in SVG can be displayed on the same screen.

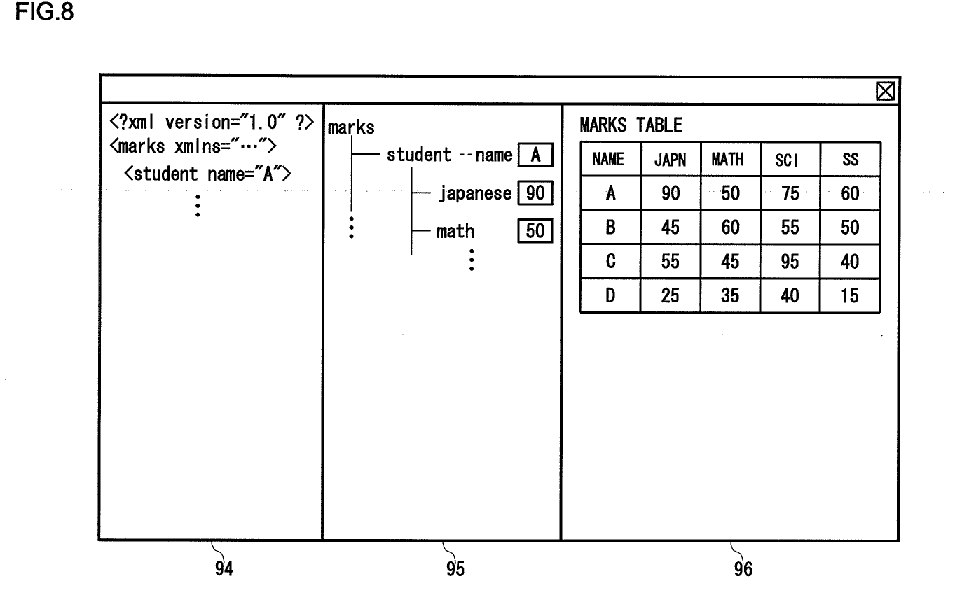

FIG. 8 shows an example of a display medium, which in a preferred but non-limiting embodiment is an edit screen, for XML documents processed by the document processing apparatus 20. In the example shown in FIG. 8, a single screen is partitioned into a plurality of areas and the XML document to be processed is displayed in a plurality of different display formats at the respective areas. The source of the document is displayed in an area 94, the tree structure of the document is displayed in an area 95, and the table shown in FIG. 5 and described in HTML is displayed in an area 96. The document can be edited in any of these areas, and when the user edits content in any of these areas, the source tree will be modified accordingly, and then each plug-in that handles the corresponding screen display updates the screen so as to effect the modification of the source tree. Specifically, display units of the plug-ins in charge of displaying the respective edit screens are registered in advance as listeners for mutation events that provide notice of a change in the source tree. When the source tree is modified by any of the plug-ins or the VC unit 80, all the display units, which are displaying the edit screen, receive the issued mutation event(s) and then update the screens. At this time, if the plug-in is executing the display through the VC function, the VC unit 80 modifies the destination tree following the modification of the source tree. Thereafter, the display unit of the plug-in modifies the screen by referring to the destination tree thus modified.

For example, when the source display and tree-view display are implemented by dedicated plug-ins, the source-display plug-in and the tree-display plug-in execute their respective displays by directly referring to the source tree without involving the destination tree. In this case, when the editing is done in any area of the screen, the source-display plug-in and the tree-display plug-in update the screen by referring to the modified source tree. Also, HTML unit 50 in charge of displaying the area 96 updates the screen by referring to the destination tree, which has been modified following the modification of the source tree.

The source display and the tree-view display can also be realized by utilizing the VC function. That is to say, an arrangement may be made in which the source and the tree structure are laid out in HTML, an XML document is mapped to HTML structure thus laid out, and HTML unit 50 displays the XML document thus mapped. In such an arrangement, three destination trees in the source format, the tree format and the table format are created. If the editing is carried out in any of the three areas on the screen, the VC unit 80 modifies the source tree and, thereafter, modifies the three destination trees in the source format, the tree format and the table format. Then, HTML unit 50 updates the three areas of the screen by referring to the three destination trees.

In this manner, a document is displayed on a single screen in a plurality of display formats, thus improving a user's convenience. For example, the user can display and edit a document in a visually easy-to-understand format using the table 90 or the like while understanding the hierarchical structure of the document by the source display or the tree display. In the above example, a single screen is partitioned into a plurality of display formats, and they are displayed simultaneously. Also, a single display format may be displayed on a single screen so that the display format can be switched according to the user's instructions. In this case, the main control unit 22 receives from the user a request for switching the display format and then instructs the respective plug-ins to switch the display.

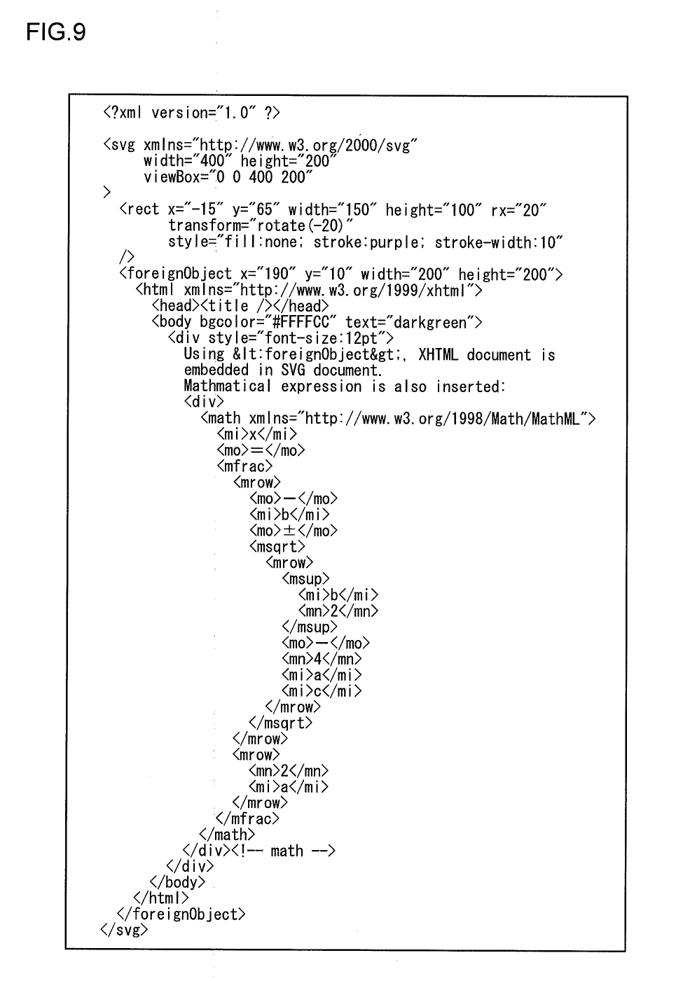

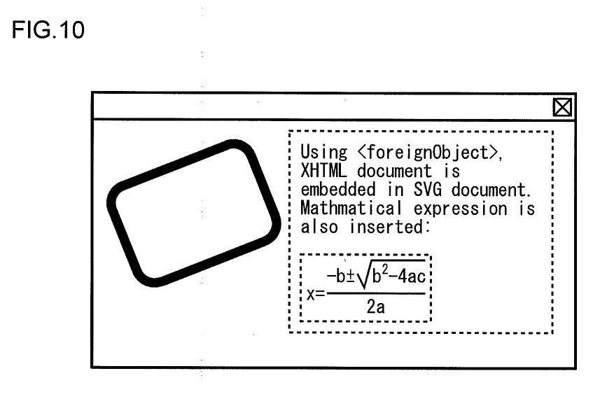

FIG. 9 illustrates another example of an XML document edited by the document processing apparatus 20. In the XML document shown in FIG. 9, an XHTML document is embedded in a “foreignObject” tag of an SVG document, and the XHTML document contains an equation described in MathML. In this case, the editing unit 24 assigns the rendering job to an appropriate display system by referring to the name space. In the example illustrated in FIG. 9, first, the editing unit 24 instructs the SVG unit 60 to render a rectangle, and then instructs HTML unit 50 to render the XHTML document. Furthermore, the editing unit 24 instructs a MathML unit (not shown) to render an equation. In this manner, the compound document containing a plurality of vocabularies is appropriately displayed. FIG. 10 illustrates the resulting display.

The displayed menu may be switched corresponding to the position of the cursor (carriage) during the editing of a document. That is, when the cursor lies in an area where an SVG document is displayed, the menu provided by the SVG unit 60, or a command set which is defined in the definition file for mapping the SVG document, is displayed. On the other hand, when the cursor lies in an area where the XHTML document is displayed, the menu provided by HTML unit 50, or a command set which is defined in the definition file for mapping HTML document, is displayed. Thus, an appropriate user interface can be presented according to the editing position.

In a case that there is neither a plug-in nor a mapping definition file suitable for any one of the vocabularies according to which the compound document has been described, a portion described in this vocabulary may be displayed in source or in tree format. In the conventional practice, when a compound document is to be opened where another document is embedded in a particular document, their contents cannot be displayed without the installation of an application to display the embedded document. According to the Base Technology, however, the XML documents, which are composed of text data, may be displayed in source or in tree format so that the contents of the documents can be ascertained. This is a characteristic of the text-based XML documents or the like.

Another advantageous aspect of the data being described in a text-based language, for example, is that, in a single compound document, a part of the compound document described in a given vocabulary can be used as reference data for another part of the same compound document described in a different vocabulary. Furthermore, when a search is made within the document, a string of characters embedded in a drawing, such as SVG, may also be search candidates.

In a document described in a particular vocabulary, tags belonging to other vocabularies may be used. Though such an XML document is generally not valid, it can be processed as a valid XML document as long as it is well-formed. In such a case, the tags thus inserted that belong to other vocabularies may be mapped using a definition file. For instance, tags such as “Important” and “Most Important” may be used so as to display a portion surrounding these tags in an emphasized manner, or may be sorted out in the command of importance.

When the user edits a document on an edit screen as shown in FIG. 10, a plug-in or a VC unit 80, which is in charge of processing the edited portion, modifies the source tree. A listener for mutation events can be registered for each Node in the source tree. Normally, a display unit of the plug-in or the VC unit 80 conforming to a vocabulary that belongs to each Node is registered as the listener. When the source tree is modified, the DOM provider 32 traces toward a higher hierarchy from the modified Node. If there is a registered listener, the DOM provider 32 issues a mutation event to the listener. For example, referring to the document shown in FIG. 9, if a Node which lies lower than the <html> Node is modified, the mutation event is notified to HTML unit 50, which is registered as a listener to the <html> Node. At the same time, the mutation event is also notified to the SVG unit 60, which is registered as a listener in an <svg> Node, which lies upper to the <html> Node. At this time, HTML unit 50 updates the display by referring to the modified source tree. Since the Nodes belonging to the vocabulary of the SVG unit 60 itself are not modified, the SVG unit 60 may disregard the mutation event.

Depending on the contents of the editing, modification of the display by HTML unit 50 may change the overall layout. In such a case, the layout is updated by a screen layout management mechanism, e.g., the plug-in that handles the display of the highest Node, in increments of display regions which are displayed according to the respective plug-ins. For example, in a case of expanding a display region managed by HTML unit 50, first, HTML unit 50 renders a part managed by HTML unit 50 itself, and determines the size of the display region. Then, the size of the display area is notified to the component that manages the screen layout so as to request the updating of the layout. Upon receipt of this notice, the component that manages the screen layout rebuilds the layout of the display area for each plug-in. Accordingly, the display of the edited portion is appropriately updated and the overall screen layout is updated.

### [Embodiment]

In the embodiment, a technique will be proposed for processing a document described in a tag set defined for a spreadsheet.

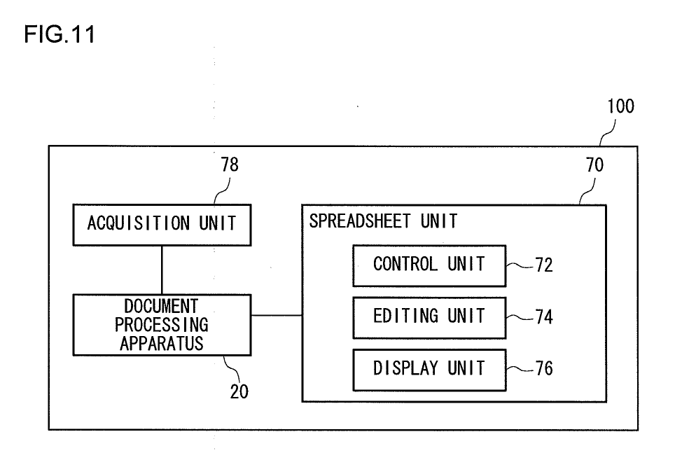

FIG. 11 shows a configuration of a document processing apparatus according to an embodiment. A document processing apparatus 100 further includes an acquisition unit 78 which acquires a document, a definition file, etc., and a spreadsheet unit 70 which processes a document described in a tag set (vocabulary) defined for the spreadsheet, in addition to the components of the document processing apparatus 20 described in the Base Technology. The other configuration and the operation are the same as those of the Base Technology.

The spreadsheet unit 70 processes a document described in a tag set defined for the spreadsheet. The spreadsheet unit 70 includes a control unit 72, an editing unit 74, and a display unit 76. The display unit 76 displays, in a spreadsheet format, the data described in the tag set defined for the spreadsheet. The control unit 72 presents commands or menus for processing the data displayed in the spreadsheet format, which allows the user to input operation instructions. The editing unit 74 receives editing requests related to the data in the respective cells in the spreadsheet, and edits the DOM of the document held by the DOM unit 30.

When the editing unit 74 receives a request to insert, into a cell in the spreadsheet, data described in a tag set other than the tag set defined for the spreadsheet, the editing unit 74 stores, in the element of the spreadsheet tag set that corresponds to the cell designated as the data insertion destination, the pointer information which points to the data which has been designated as the data to be inserted and which is described in a tag set that differs from the spreadsheet tag set. The pointer information may be described by an XPath expression. When the editing unit 74 receives a notice indicating that the reference source for the data thus inserted has been edited, the editing unit 74 edits the element that corresponds to the cell into which the insertion data has been inserted, by referring to the insertion data thus edited.

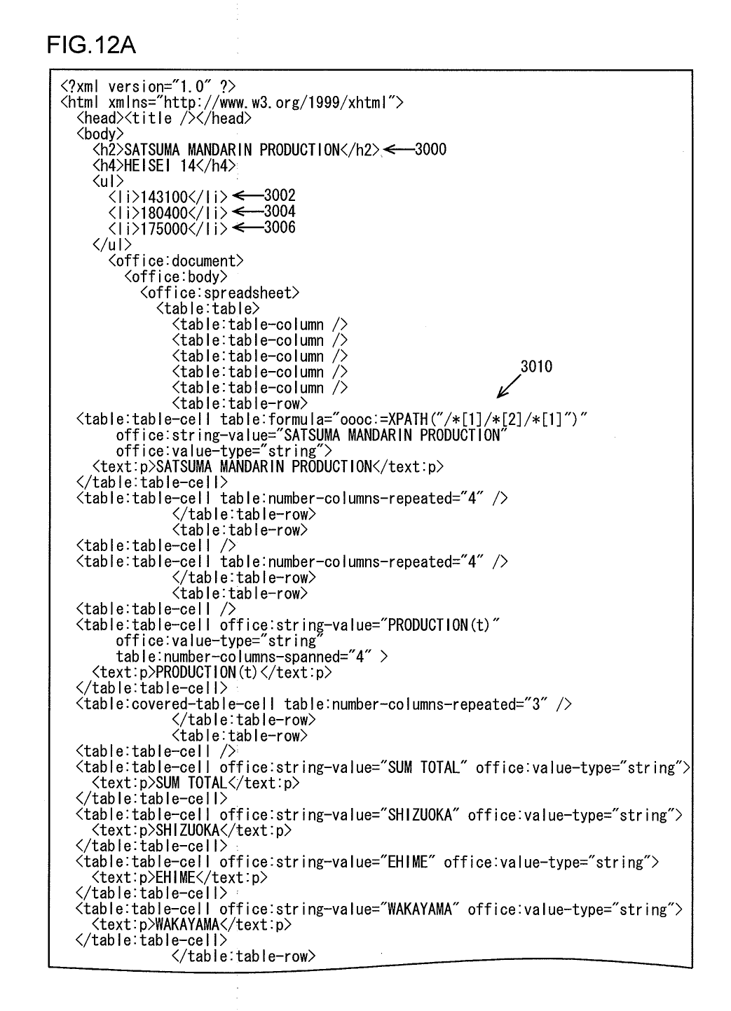

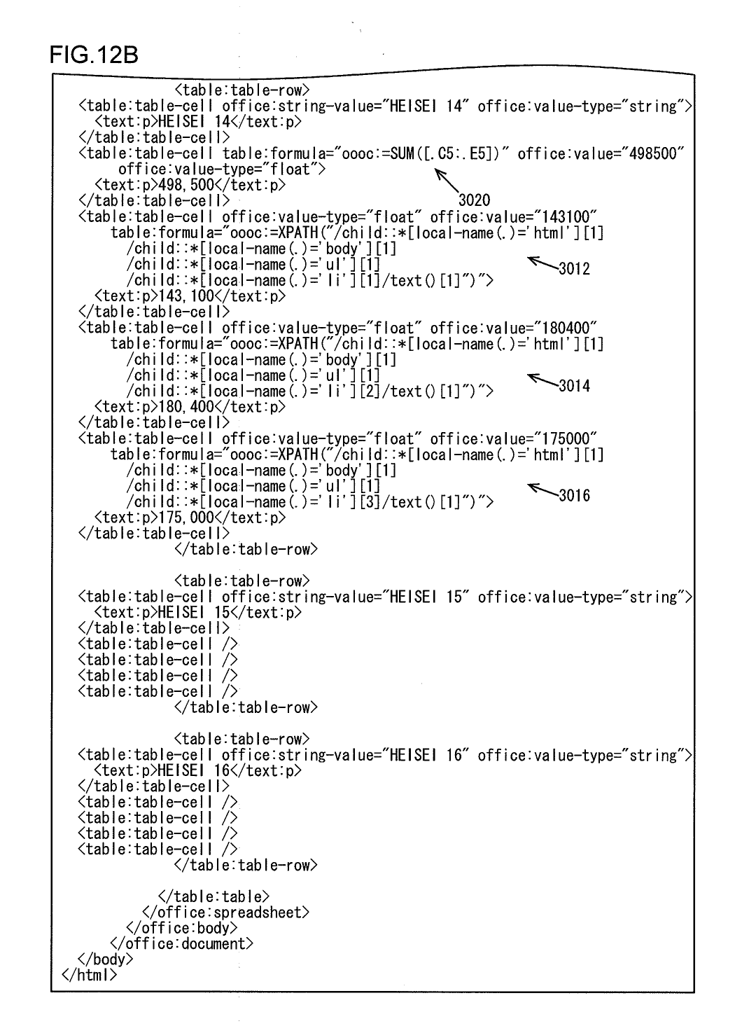

FIGS. 12A and 12B show a sample document. This sample document is a compound document containing multiple vocabularies, in which a document described in XHTML contains a document described in a vocabulary for a spreadsheet. For simplification, the information with respect to the styles, the namespace definition, etc., are not shown.

The “table” vocabulary defined for the spreadsheet has a structure similar to the “table” element defined in XHTML, and includes an element which defines a column, i.e., the “table:table-column” element, an element which defines a row, i.e., the “table:table-row” element, and an element which defines a cell, i.e., the “table:table-cell” element, and so forth. The sample document shown in FIG. 12A contains five “table:table-column” elements, and seven “table:table-row” elements, which represents a spreadsheet having five columns and seven rows. The corresponding cell data is described in a “table:table-cell” element contained in each “table:table-row” element.

The data of the “h2” element 3000, which is the first sub-element of the second sub-element, i.e., the “body” element, of the top element, i.e., the “html” element, of this document is inserted into the cell at the first row of the first column by the XPath expression 3010.

In the cell at the fifth row of the third column, the text node value of the first “li” element 3002 of this document is specified by the XPath expression 3012 as the attribute value of the “office:formula” attribute for storing an expression. Furthermore, the “office:value-type” attribute for storing the data type stores “float” which indicates that the data is floating type data. Moreover, the “office:value” attribute for storing the data value stores the value “143100”. In addition, as a sub-element in the “table:table-cell” element, an element for storing a character string, i.e., the “text:p” element, is provided, which stores the text value “143,100”.

In the same way, the text node value of the second “li” element 3004 is inserted into the cell at the fifth row of the fourth column by the XPath expression 3014. Furthermore, the text node value of the third “li” element 3006 is inserted into the cell at the fifth row of the fifth column by the XPath expression 3016. Moreover, in the cell at the fifth row of the second column, an expression 3020 is defined, which is used to calculate the sum total of the values of the cells from the cell at the fifth row of the third column to the cell at the fifth row of the fifth column, and the “office:value” attribute thereof stores the value “498500” which is the calculation result obtained by the expression. In addition, as a sub-element of the “table:table-cell” element, a “text:p” element is provided for storing a character string, which stores the text value “498,500”.

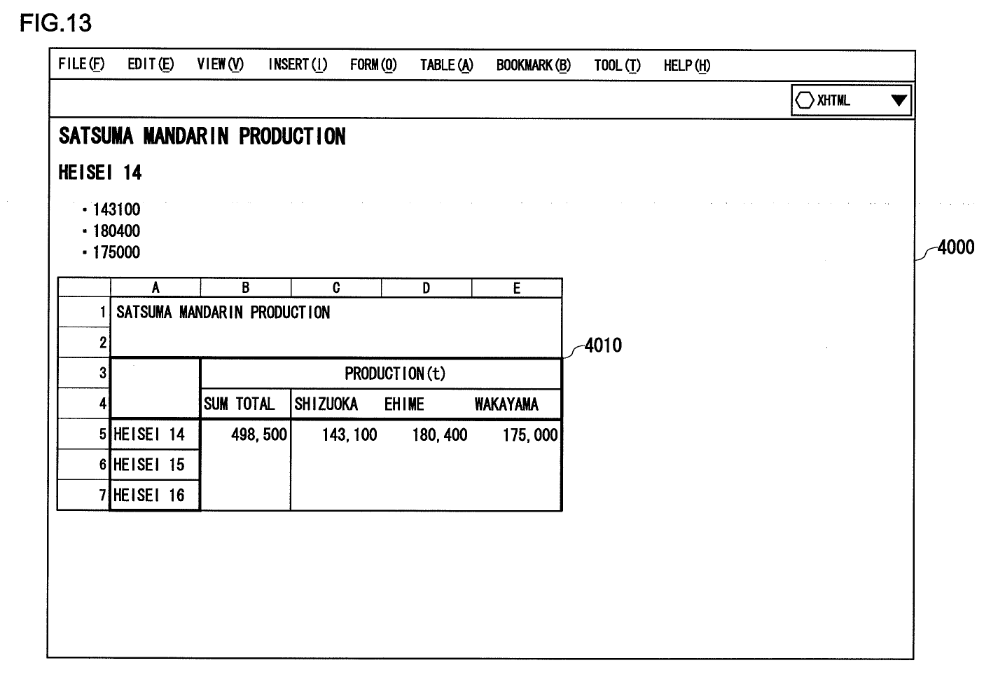

FIG. 13 shows an example of a screen 4000 which displays the sample document shown in FIGS. 12A and 12B. The display unit 76 displays, as the spreadsheet 4010, the data described in the “table” vocabulary defined for the spreadsheet contained in the document. When a request is received from the user via the screen 4000 to insert data described in a tag set other than the tag set defined for the spreadsheet contained in the document, the editing unit 74 presents a screen which allows the user to select data.

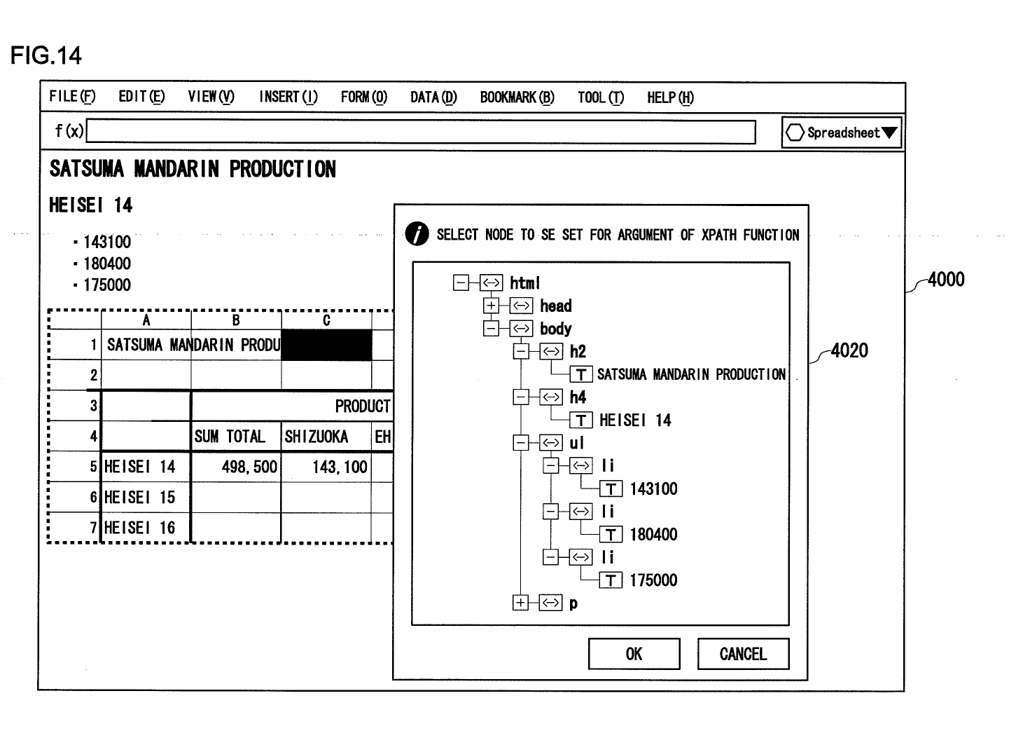

FIG. 14 shows an example of a data selection reception screen 4020 presented by the editing unit 74. Upon receiving a request to insert data, the editing unit 74 presents the data selection reception screen 4020 which displays the data contained in the document in tree form, which allows the user to select the data to be inserted. When the user clicks a node to be inserted and presses an OK button, the editing unit 74 stores the XPath expression for the node thus selected, as the “office:formula” attribute value of the “table:table-cell” element of the insertion target cell, and stores the text node value thereof in the “office:value” attribute. In this case, in a case in which the data type of the data to be inserted can be acquired based upon the schema, the definition file, or the like, the editing unit 74 stores the data type in the “office:value-type” attribute. In a case in which the data type is unknown, such an arrangement may query the user. Furthermore, the editing unit 74 formats the insertion target data according to the display format for the data in the insertion destination cell, and stores the data thus formatted in the “text:p” element. For example, in a case in which the insertion target data is a value “143100”, and in a case in which the display format “add a comma every three digits” is set, the test value “143,100” is stored.

When the editing unit 74 has modified the source DOM of the document described in the spreadsheet vocabulary, a mutation event issued by the DOM unit 30 is transmitted to the spreadsheet unit 70 as a notice. The display unit 76 updates the display of the spreadsheet 4010 with reference to the source DOM.

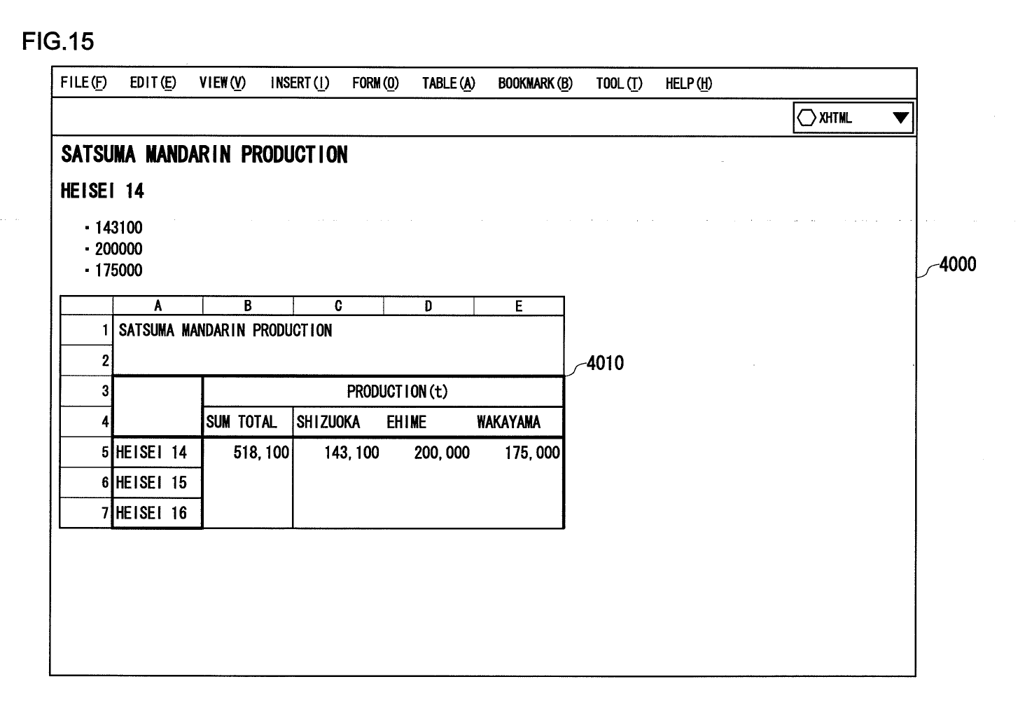

FIG. 15 shows an example of the screen 4000 when the reference data is updated. Upon the user editing the text data of the second “li” element 3004 via the screen 4000, the HTML unit 50 modifies the source DOM. A mutation event issued by the DOM unit 30 is transmitted to the HTML unit 50 as a notice, and the display unit 56 updates the display. Furthermore, the mutation event is also transmitted as a notice to the spreadsheet unit 70 which uses this data as a reference. The editing unit 74 modifies the “table:table-cell” element of the cell at the fifth row of the fourth column which refers to the second “li” element 3004 according to the XPath expression 3014. A mutation event, which is a notice of this modification, is transmitted from the DOM unit 30 to the spreadsheet unit 70, and the display unit 76 updates the display of the spreadsheet 4010. Thus, the screen 4000 shown in FIG. 13 is updated to the screen 4000 shown in FIG. 15.

An arrangement may be made in which, when the editing unit 74 receives an instruction to insert a fragment composed of multiple elements contained in the document, the editing unit 74 inserts the fragment as the insertion target data. For example, in FIG. 14, in a case in which the user has selected the “ul” node as the insertion target data, the editing unit 74 inserts a fragment containing the “ul” element and the elements that lie lower than the “ul” element as the insertion target data. In this case, an arrangement may be made in which the editing unit 74 adds a suitable number of “office:value” attributes and “text:p” elements for the text nodes that lie lower than the “ul” element, and stores the text node values thereof in the attributes and elements thus added. Also, data having the same structure as that of the fragment thus inserted may be added at a level that lies lower than the “table:table-cell element”. The data of the fragment thus inserted may be referred to by other cells in the spreadsheet, and may be used in an expression. As described above, such an arrangement allows a fragment to be inserted into a cell, thereby allowing structured data to be handled in a spreadsheet.

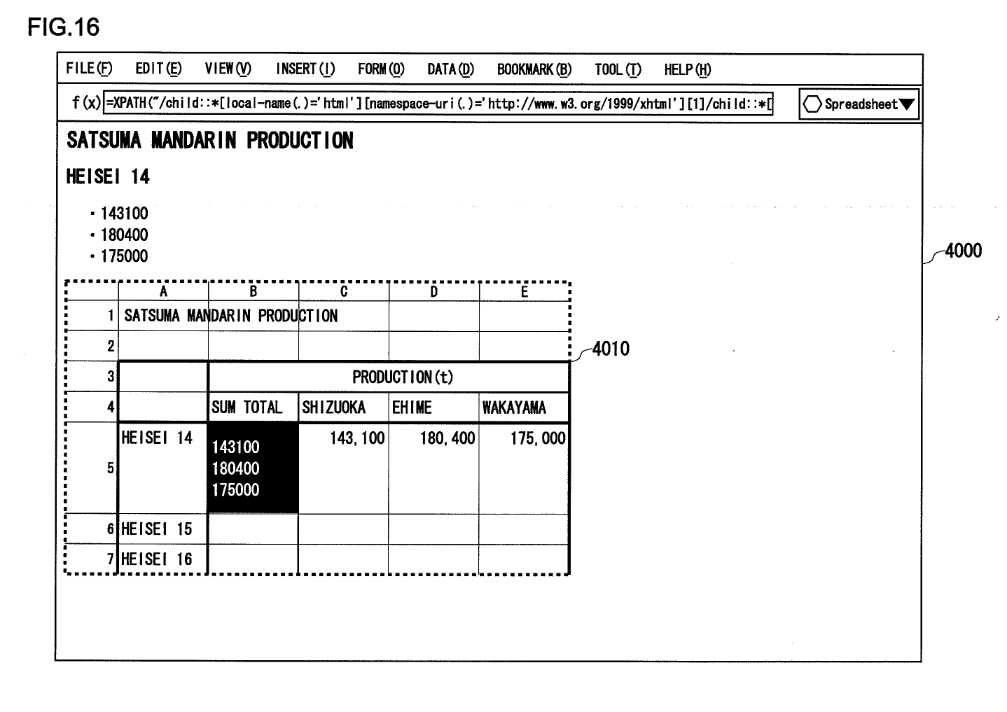

FIG. 16 shows an example of the screen 4000 after a fragment has been inserted into a cell. The fragment that lies lower than the XHTML “ul” element is inserted in the cell at the fifth row of the second column in the spreadsheet 4010. Specifically, the text values of the text nodes that lie lower than the “ul” element are displayed in the cell at the fifth row of the second column in a list form.

Also, the editing unit 74 may define dedicated functions using data described in tag set, in increments of tag sets used to describe insertion target data, as functions which can be described in expressions to be written to cells in a spreadsheet. Upon receiving the input of an expression containing such a function, the editing unit 74 may insert the result obtained by calculating the expression. For example, before graphic data described in SVG is referred to, the editing unit 74 may define a function for calculating the area of a graphic object.

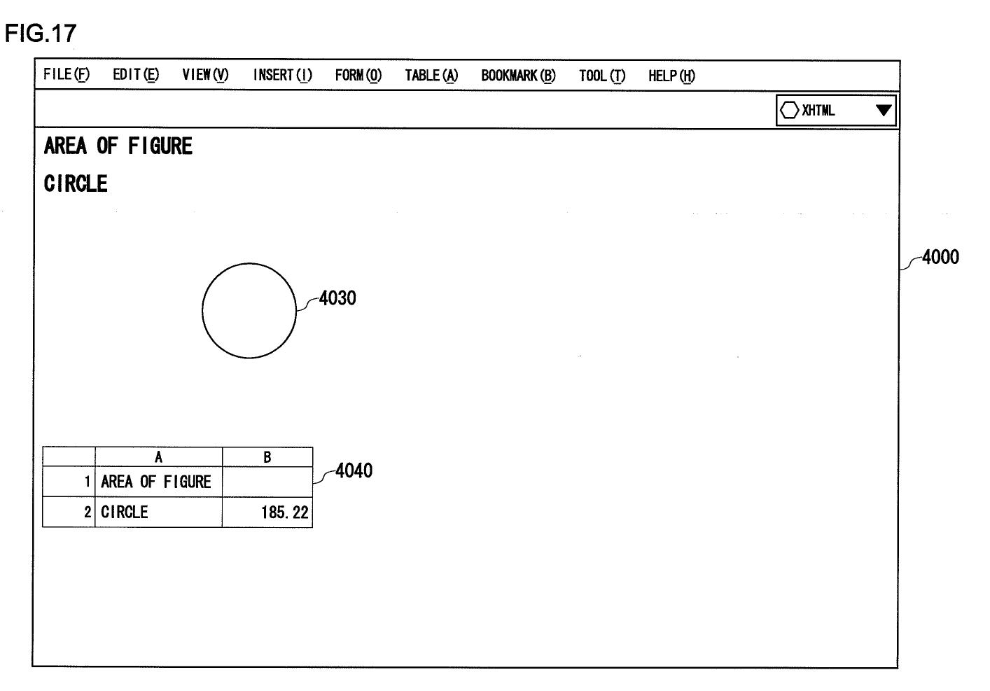

FIG. 17 shows an example of the screen 4000 after a dedicated function has been inserted into the spreadsheet. The document contains a circle object 4030 described in SVG. An expression for calculating the area of the circle object 4030 is inserted into the cell at the second row of the second column in a spreadsheet 4040. Upon the user changing the radius of the circle object 4030 via the screen 4000, the SVG unit 60 modifies the source DOM. Upon receiving a mutation event, the editing unit 74 acquires the radius of the circle object thus changed by referring to the element that corresponds to the circle object 4030 displayed in the source DOM, and substitutes the area of the circle object 4030 into the element that corresponds to the cell at the second row of the second column in the spreadsheet 4040. As described above, by defining a function that matches the vocabulary used in the reference source, such an arrangement provides a more flexible and highly functional spreadsheet.

Description has been made regarding the present invention with reference to the embodiments. The above-described embodiments have been described for exemplary purposes only, and are by no means intended to be interpreted restrictively. Rather, it can be readily conceived by those skilled in this art that various modifications may be made by making various combinations of the aforementioned components or processes, which are also encompassed in the technical scope of the present invention.

Description has been made in the above embodiments regarding an arrangement for processing an XML document. Also, the document processing apparatus 100 according to the present embodiment is capable of processing other markup languages, e.g., SGML, HTML, etc.

### INDUSTRIAL APPLICABILITY

Thus, the present invention is applicable to a document processing apparatus which processes a document structured by a markup language.

1. A document processing apparatus comprising:
a display unit which displays, in a spreadsheet format, data which is contained in a document and which is described in a tag set defined for a spreadsheet; and an editing unit which inserts, into the spreadsheet, data which is contained in the document and which is described in a tag set that differs from the tag set for the spreadsheet.

2. A document processing apparatus according to claim 1, wherein the editing unit stores pointer information pointing to data, which has been designated as insertion target data and which is described in a tag set that differs from the tag set for the spreadsheet, in an element of the tag set for the spreadsheet which corresponds to a cell designated as a data insertion destination.

3. A document processing apparatus according to claim 1, wherein, upon receiving a notice which indicates that the insertion target data has been edited, the editing unit edits, with reference to the insertion target data thus edited, an element that corresponds to the cell into which the insertion target data was inserted.

4. A document processing apparatus according to claim 1, wherein the editing unit defines a dedicated function using data described in the tag set, in increments of tag sets used to describe the insertion target data,
and wherein, upon receiving an input of an expression containing the function thus defined, the editing unit inserts the result obtained by calculating the expression.

5. A document processing apparatus according to claim 1, wherein, upon receiving an instruction to insert a fragment composed of a plurality of elements contained in the document, the editing unit inserts the fragment as the insertion target data.

6. A document processing apparatus according to claim 1, wherein, when the editing unit receives an instruction for the insertion target data, the editing unit presents a screen in which the data contained in the document is displayed in a tree format, which allows the user to input an instruction for the insertion target data.

7. A document processing method comprising:
displaying, in a spreadsheet format, data which is contained in a document and which is described in a tag set defined for a spreadsheet; and
inserting, into the spreadsheet, data which is contained in the document and which is described in a tag set that differs from the tag set for the spreadsheet.

8. A computer program product comprising:
a module which displays, in a spreadsheet format, data which is contained in a document and which is described in a tag set defined for a spreadsheet; and
a module which inserts, into the spreadsheet, data which is contained in the document and which is described in a tag set that differs from the tag set for the spreadsheet.
